(19) United States
(12) Patent Application Publication
(10) Pub. No.: US 2009/0081511 A1
(43) Pub. Date: Mar. 26, 2009

(54) Electrode Catalyst for Fuel Cell

(76) Inventors: Kuninori Miyazaki, Himeji-shi (JP); Junji Okamura, Himeji-shi (JP); Noboru Sugishima, Himeji-shi (JP); Koichi Yamamoto, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/886,538

(22) PCT Filed: Mar. 15, 2006
(86) PCT No.: PCT/JP2006/305144

§ 371 Date: Sep. 17, 2007

(30) Foreign Application Priority Data
Mar. 18, 2005 (JP) 2005-079094
Jul. 22, 2005 (JP) 2005-212207

(51) Int. Cl. H01M 4/92; H01M 4/90

(52) U.S. Cl. 429/30; 429/44

(57) ABSTRACT

An object of the present invention is to provide an electrode catalyst which is excellent in catalyst performance compared with a conventional electrode catalyst. It is also an object of the present invention to provide an electrode composition for fuel cell and a polymer electrolyte fuel cell using the electrode catalyst. The fuel cell electrode catalyst of the present invention is characterized in that a catalyst component is supported on a carrier having a specific feature.

### TECHNICAL FIELD

The present invention relates to an electrode catalyst for polymer electrolyte fuel cell, an electrode catalyst composition containing the electrode catalyst, and a fuel cell having an electrode formed of the electrode catalyst composition.

### BACKGROUND ART

A fuel cell is a power generating device which electrochemically reacts a fuel such as hydrogen and methanol with oxygen to directly obtain electrical energy. Accordingly, a fuel cell does not discharge harmful nitrogen oxide and sulfur oxide, unlike a thermal power system. Additionally, a fuel cell is high in power generation efficiency because of a smaller loss of thermal energy and kinetic energy compared with other power generation system. Therefore, a fuel cell is expected to be a future power generation system which is highly clean and efficient.

Fuel cells can be classified into phosphoric acid fuel cell, molten carbonate fuel cell, polymer electrolyte fuel cell, solid oxide fuel cell and the like according to the type of electrolyte. Among them, a polymer electrolyte fuel cell can generate electricity in a lower temperature range than other fuel cells and can be easily miniaturized, so that the fuel cell has a possibility to be applied to a variety of uses such as a power source for automobiles, a household power source, and a mobile power source.

A polymer electrolyte fuel cell has a membrane electrode assembly as a constitutional unit in which an anode and a cathode are formed on both sides of a polymer electrolyte membrane having proton conductivity and devoid of electron conductivity (electrical conductivity), consisting of perfluoro sulfonate ion exchange resin or the like. Each electrode contains a catalyst layer having a polymer electrolyte which exhibits proton conductivity as well as a catalyst on the side of the polymer electrolyte membrane, and a gas diffusion layer having both air permeability and electrical conductivity in the outside thereof.

During power generation, a fuel such as hydrogen and methanol is supplied to anode, while oxygen or air is supplied to cathode. As a result, protons and electrons are generated in anode due to a catalytic action, and the generated proton goes through the electrolyte membrane and a reaction in which the proton is oxidized in the cathode side to generate water progresses, thereby obtaining electricity.

As a fuel supplied to anode, a reformed gas obtained by reacting a hydrocarbon natural gas, petroleum oil, coal and the like with water vapor is generally used. In this case, the reformed gas contains carbon monoxide, carbon dioxide, water vapor and unreacted hydrocarbon in addition to hydrogen. Among them, carbon monoxide adsorbs to a surface of platinum which is an electrode catalyst component of anode and lowers catalyst performance to cause degradation of power generation performance significantly.

It is known that carbon monoxide generated by electrochemical oxidation reaction of liquid fuel reduces power generation performance in the same manner, when a liquid fuel such as methanol is used as anode fuel. Further, liquid fuel such as methanol is less subject to electrochemical oxidation reaction compared with hydrogen. Therefore, there is a problem in that an energy required for electrochemical oxidation reaction of liquid fuel in electrode catalyst, namely reaction overpotential, becomes larger than when hydrogen fuel is used, resulting in reduction of voltage to be obtained.

For solving these problems, proposed is a catalyst in which an alloy of platinum and ruthenium or platinum and tin is supported on a conductive carbon material such as carbon black. Further, various carrier materials supporting catalyst components are examined.

For example, as a carrier material other than carbon black which is a conductive carbon material, a carrier composed of titanium oxide alone or titanium oxide added with niobium is proposed (Nineth Fuel Cell Symposium, p. 14, May 15 and 16, 2002, Fuel Cell Development Information Center).

Additionally, Japanese Unexamined Patent Publication No. 2002-246033 discloses an electrode catalyst in which a catalyst component is supported on a carrier containing SiO₂ as a main component. The catalyst is aimed at solving the problem of irregularity in power generation property in a fuel cell produced using an electrode catalyst containing carbon black which is a conventional conductive carbon material as a carrier.

### DISCLOSURE OF THE INVENTION

As described above, there are problems of catalyst poisoning due to carbon monoxide and lowering of power generation efficiency due to an increase of reaction overpotential when a liquid fuel such as methanol is used in a polymer electrolyte fuel cell. Although there have been technologies which take these problems into consideration, such technologies are not sufficient in order to put fuel cell to practical use, and thus an electrode catalyst capable of exerting a higher catalyst performance is needed.

Therefore, an object of the present invention is to provide an electrode catalyst which is excellent in catalyst performance compared with a conventional electrode catalyst. Further, it is also an object of the present invention to provide an electrode composition for fuel cell and a polymer electrolyte fuel cell using the electrode catalyst.

The inventor of the present invention intensively studied structures of electrode catalyst for solving the above problems, and finally accomplished the present invention with a discovery that an electrode catalyst in which a catalyst component is supported on a carrier having a specific feature is highly excellent in catalyst performance.

The electrode catalyst for fuel cell according to the present invention characterized in that:

a catalyst component is supported on a below-mentioned carrier (1) or (2); and

a percentage of the catalyst component in the electrode catalyst when the carrier (2) is selected is 50 to 80% by mass.

Carrier (1): Titanate

Carrier (2): SiO₂ having a BET specific surface area of 100 to 500 m²/g and an oil absorption value of 1.6 to 3.7 mL/g

Further, the electrode catalyst composition for fuel cell according to the present invention contains the above electrode catalyst for fuel cell, a conductive carbon material and a polymer electrolyte.

The fuel cell of the present invention has an electrode formed of the electrode catalyst composition for fuel cell.

The electrode catalyst for fuel cell (hereinafter simply referred to as “electrode catalyst” occasionally) according to the present invention has excellent catalyst performance compared with a conventional electrode catalyst. Therefore, a polymer electrolyte fuel cell using the electrode catalyst of the present invention can provide a stable power voltage for a long period of time.

### BRIEF DESCRIPTION OF THE DRAWINGS

FIG. 1 is the powder X-ray diffraction chart of the powder obtained in Example of preparing catalyst 1.

FIG. 2 is a graph showing a relation between a value of absorbed oil of SiO₂ and a methanol oxidation current value.

### BEST MODE FOR CARRYING OUT THE INVENTION

The electrode catalyst for fuel cell according to the present invention characterized in that:

a catalyst component is supported on a below-mentioned carrier (1) or (2); and

a percentage of the catalyst component in the electrode catalyst when the carrier (2) is selected is 50 to 80% by mass.

Carrier (1): Titanate

Carrier (2): SiO₂ having a BET specific surface area of 100 to 500 m²/g and an oil absorption value of 1.6 to 3.7 mL/g

The type of the catalyst component used in the fuel cell electrode catalyst of the present invention is not particularly limited as long as the catalyst can catalyze a reaction of generating proton and electron from hydrogen in anode and generating water from oxygen, proton and electron in cathode. A noble metal can be used alone or two or more noble metals can be used in combination. In case that two or more noble metals are used in combination, these metals may be used independently or may be used as an alloy thereof.

A preferable catalyst component includes one, two or more selected from a group consisting of Pt, Pd, Ru, Rh, Ir, Au and Ag. These catalyst components have high performance as an electrode catalyst for a polymer electrolyte fuel cell. In particular, Pt, Ru, Pt.Ru, Pt.Rh, Pt.Ru.Rh, Pt.Ru.Ir, Pt.Ru.Pd and the like are preferable, and Pt.Ru is the most preferable as the catalyst component of anode, and Pt is the most preferable as the catalyst component of cathode.

The carrier (1) of the present invention is titanate. The titanate is a crystalline compound having a regularly crystallized structure consisting of titanium acid and other metal ion which is a counter ion of the titanium acid, and the titanate has a totally different structure and properties from those of a simple mixture of a titanium oxide and other metal oxide or an amorphous composite oxide devoid of clear crystalline structure. Namely, titanate having high crystallinity is used in the present invention. The titanate is occasionally called crystalline titanate. For example, in a case of crystalline titanate consisting of titanium acid and zirconium ion, a clear peak attributed to TiO₂ and ZrO₂ is not observed in an X-ray diffraction diagram thereof, but the titanate can be confirmed by a clear peak attributed to ZrTiO₄.

Examples of a metal ion constituting the titanate of the present invention include Ca ion, Mg ion, Sr ion, Ba ion, Zr ion, Cd ion, La ion, Al ion, and Nd ion.

As the titanate of the present invention, any of those generally known as titanate can be used. Specifically, magnesium titanate (MgTiO₃), barium titanate (BaTiO₃), zirconium titanate (ZrTiO₄), and strontium titanate (SrTiO₃) are preferably used.

In the present invention, a titanate having a specific surface area of 20 m²/g or less, more preferably 10 m²/g or less, is preferable among the titanates. In an electrode catalyst for fuel cell, a carrier having a larger specific surface area is generally considered better. However, according to a finding of the present inventors, titanates having a smaller specific surface area have higher performance as a carrier of an electrode catalyst (refer to Table 2 of Examples). A specific surface area of the carrier can be measured by BET method. The specific surface area is preferably 1 m²/g or more.

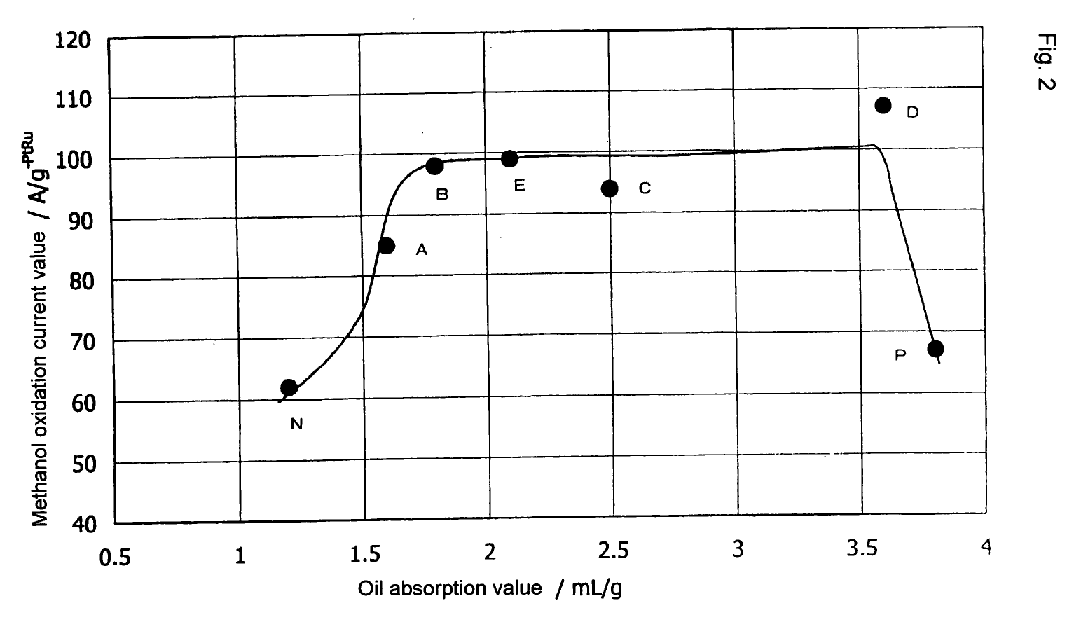

The carrier (2) of the present invention is SiO₂ having a BET specific surface area of 100 to 500 m²/g and an oil absorption value of 1.6 to 3.7 mL/g. According to a finding of the present inventors, in case that an electrode catalyst using SiO₂ as a carrier has a BET specific surface area and an oil absorption value outside the range, its performance is markedly lowered. On the other hand, an electrode catalyst using SiO₂ having a BET specific surface area and an oil absorption value within the range as a carrier has highly excellent performance (refer to FIG. 2). A more preferred oil absorption value is 1.8 mL/g or more and 3.6 mL/g or less.

The oil absorption value of the carrier (2) of the present invention is measured in accordance with JIS K5101-13-1. Specifically, pulverized sample is placed on a glass plate, and purified linseed oil is dropped onto the sample in a small amount using a burett having a capacity of 10 mL, while the purified linseed oil is kneaded into the sample with a stainless-steel spatula. The operation is repeated until the end point where the paste becomes soft, at which the amount of the linseed oil needed is recorded. The measurement is carried out a plurality of times to obtain an average value thereof. The oil absorption value of the present invention is to be an amount of linseed oil per 1 g of the sample.

The value obtained by measuring the oil absorption amount represents an amount of oil required to fill voids in a structure of a certain amount of SiO₂. The value reflects a structure of each of SiO₂, namely, a degree of development of three-dimensional network due to connection of primary particle or aggregation of agglomerate particles. In other words, SiO₂ having a large oil absorption value has a developed three-dimensional network and a structure in which particles are connected in beaded form. A degree of development of the three-dimensional network of SiO₂ can greatly influence the electrode layer structure in a fuel cell.

An electrode layer contains an electrode catalyst, a conductive carbon material and a polymer electrolyte. It is preferable that contact areas thereof are large; additionally, it is also required to have high diffusibility for fuel or gas for an efficient electrochemical reaction. In response to such a demand, if SiO₂ having an oil absorption value less than 1.6 mL/g, i.e. SiO₂ in which three-dimensional network is undeveloped, is used as a carrier of an electrode catalyst, the electrode layer becomes dense in extreme, so that dispersibility for fuel or gas is lowered and an efficient power generation becomes impossible. On the other hand, if SiO₂ having an oil absorption value exceeding 3.7 mL/g is used as a carrier of an electrode catalyst, a catalyst particle supported in a deep part of the excessively developed three-dimensional network cannot contact a conductive carbon material and a polymer electrolyte, resulting in reduction of electrochemically effective catalyst particles, so that an effective electrochemical reaction becomes impossible. The SiO₂ having an excessively large oil absorption value is usually small in bulk specific gravity, so that when it is used as a carrier of an electrode catalyst, there is a problem in that a thickness of the electrode layer becomes thick and resistance value becomes high.

The carrier (2) of the present invention has a BET specific surface area of 100 to 500 m²/g. As in a result of experiment described in the following, an electrode catalyst using a carrier having a BET specific surface area outside the range is inferior in performance, while an electrode catalyst having a carrier within the range is excellent in the performance. The BET specific surface area may be measured by nitrogen gas absorption method.

In the electrode catalyst of the present invention, it is preferable to further support one or two oxides of metal selected from a group consisting of Ce, La, Ta, Ni, W, Re, In, Co, Mn, Nb, Ga, V, Zn and Y. These oxides can further enhance the performance of the electrode catalyst.

A kind of the oxide to be supported may be suitably selected according to the kind of the carrier. For example, in case that the carrier (1) is used, one or more selected from CeO₂, NiO and WO₃ may be selected for use, while in case that the carrier (2) is used, one or more selected from CeO₂, La₂O₃ and Ta₂O₅ may be selected for use.

When the carrier (2) is used, a percentage of the catalyst component in the electrode catalyst of the present invention, namely a percentage of the catalyst component in a total of the catalyst component, the carrier and the oxide is 50 to 80% by mass, preferably 60 to 80% by mass. As in the following Examples, the carrier (2) which meets the provisions with respect to the percentages of the BET specific surface area, oil absorption value and the ratio of the catalyst component is excellent as a carrier of a fuel cell electrode catalyst.

When the carrier (1) is used, an amount of the catalyst component supported is not particularly limited as long as the electrode catalyst can exert excellent catalyst performance, and it is preferably 5 to 80% by mass, more preferably 20 to 70% by mass.

When the oxide is further supported, a percentage of the oxide in the electrode catalyst of the present invention is preferably 1 to 10% by mass, more preferably 2 to 5% by mass.

The carrier (1) of the present invention can be produced in accordance with a conventional method by mixing an oxide, hydroxide or carbonate of titanium with an oxide, hydroxide or carbonate of another metal and calcining at 900° C. or more. To obtain a crystalline titanate having a desired specific surface area, a calcination temperature thereof may be suitably adjusted (refer to Examples of preparing catalyst 8 to 10). The higher the calcination temperature is set, the higher the crystallinity of the obtained titanate becomes and the smaller the specific surface area can be made.

For example, zirconium titanate (ZrTiO₄) consisting of titanium acid and zirconium ion can be obtained by mixing an aqueous solution of zirconium oxychloride and sulfuric solution of titanyl sulfate, adding ammonia thereto to generate a gel. Then, the gel is filtrated, rinsed with water, dried and thereafter calcined.

The carrier (2) of the present invention can be synthesized by reacting a mineral acid such as sulfuric acid and sodium silicate. During the time, reaction is allowed to progress while pH of the reaction liquid is maintained on acid side to suppress coarsening of a primary particle, and the following maturation allow agglomerate particle to be formed from the primary particle. Here, with a progress of the reaction in the solution and a development of the three-dimensional network formed by the agglomerate particles, a gel form material is generated from the solution. In this case, a degree of development of the three-dimensional network can be controlled by allowing gelation to progress in a state where a strong shear strength is applied using mixing nozzle, so that SiO₂ having a desired oil absorption value can be synthesized. By rinsing the resultant gel form material sufficiently with water to remove impurities followed by drying, the carrier (2) of the present invention can be obtained. In the drying step, other than drying under a usual heated atmosphere, lyophilization, drying in a vacuum at a low temperature, drying using supercritical carbon dioxide and the like may be carried out.

The carrier (2) of the present invention is not limited to the one synthesized by the above methods, and for example, an oil absorption value and a specific surface area of commercially available SiO₂ may be measured so as to select one which meets the provision of the present invention for use. For example, Tokusil GU, Tokusil U, Tokusil NR (all manufactured by Tokuyama Corporation), Nipgel AZ200 and Nipgel BY400 (all manufactured by Tosoh Silica Corporation), and the like may be used.

The electrode catalyst of the present invention can be obtained, for example, by making the catalyst component support on the carrier (1) or (2) in accordance with a publicly known method such as impregnation. Specifically, for example, a water soluble compound containing a noble metal atom such as a noble metal salt including diamine dinitro platinum, ruthenium nitrate and the like is dissolved in water, and the aqueous solution thereof is impregnated with the carrier and dried followed by being heated under reducing atmosphere to be subjected to reduction treatment. By the reduction treatment, the noble metal compound is reduced, so that the catalyst component is to be supported on the carrier in metal form. A reducing atmosphere, heating temperature and the like when the reduction treatment is carried out are not particularly limited, and can be suitably selected as long as the catalyst component is supported in metal form. Specifically, for example, a heating may be carried out in a mixed gas consisting hydrogen and nitrogen at 100 to 800° C.

A method of supporting the oxide is not particularly limited, and may be in accordance with a conventional method. For example, when CeO₂ is supported, a metal salt such as cerium nitrate and cerium acetate is dissolved in a predetermined amount in a solvent such as pure water, and after the carrier is added to the resultant solution and is homogenously dispersed, the metal salt is supported on the carrier by, for example, evaporating the solvent. Next, the resultant powder is subjected to heat treatment in an oxygen-containing gas such as air at 200 to 700° C. to decompose and oxidize the metal salt and have CeO₂ supported on the carrier.

In case that the oxide is supported, first, the oxide is preferably supported on the carrier before supporting the catalyst component.

The electrode catalyst of the present invention can be used both for an anode and a cathode. The electrode catalyst of the present invention is preferably used particularly for an anode to enhance power generation efficiency using the electrode catalyst since there is a problem of catalyst poisoning caused by carbon monoxide in an anode.

The electrode catalyst composition of the present invention contains a conductive carbon material and a polymer electrolyte other than the electrode catalyst for fuel cell according to the present invention. The conductive carbon material is added so as to secure electrical conductivity of the catalyst layer, and carbon black, carbon particle, carbon fiber, carbon nanotube and the like may be used.

The conductive carbon material may be added in an amount in which the electrode catalyst of the present invention can exert catalyst performance effectively and exhibit electrical conductivity. For example, the conductive carbon material can be blended in an amount of 50 to 500 parts by mass relative to 100 parts by mass of the electrode catalyst.

The polymer electrolyte has a role of delivering a proton generated from fuel by catalyst reaction to a polymer electrolyte membrane. For example, a fluororesin having a sulfonate group such as Nafion (manufactured by DUPONT CO.), Flemion (manufactured by Asahi Kasei Corporation), and Aciplex (manufactured by Asahi Glass Co., Ltd.), and an inorganic material such as tungsten acid and phosphotungstic acid may be used.

A ratio of the polymer electrolyte in the electrode composition of the present invention may be suitably determined so that necessary proton conductivity can be obtained when the electrode is formed. For example, 10 to 200 parts by mass of the polymer electrolyte may be suitably added relative to 100 parts by mass of the electrode catalyst.

In the electrode catalyst composition of the present invention, an electrode catalyst other than the electrode catalyst of the present invention may be added. For example, a catalyst component may be supported on an entire or a part of conductive carbon material. A method of support in this case may be a same as that of the carrier of the present invention. However, in order to exert the performance of the electrode catalyst of the present invention effectively, in case that another electrode catalyst is added, the electrode catalyst of the present invention is preferably 10% by mass or more, more preferably 20% by mass or more, even more preferably 50% by mass or more, further preferably 60% by mass or more relative to total electrode catalyst. Preferably, the electrode catalyst included in the electrode catalyst composition of the present invention entirely consists of the electrode catalyst of the present invention.

An electrode (anode and cathode) of a polymer electrolyte fuel cell contains a catalyst layer on a side of a polymer electrolyte and a gas diffusion layer on an outside thereof. As the gas diffusion layer which have excellent gas permeability and electrical conductivity, carbon paper and carbon cloth having a thickness of about 100 to 300 μm are used. The carbon paper and the like may be subjected to water repellent treatment using, for example, polytetrafluoroethylene (PTFE). Accordingly, an electrode can be formed from the electrode composition of the present invention by adding a water repellent material, a binder and the like to the electrode catalyst of the present invention, the conductive carbon material and the polymer electrolyte as necessary, and homogenously mixing the mixture with water and an organic solvent such as isopropyl alcohol to prepare a paste, and applying the paste on a gas diffusion layer of the carbon paper and the like followed by drying.

The resultant anode and cathode can be formed into a membrane electrode assembly by hot pressing with polymer electrolyte membrane interposed therebetween. In this case, the catalyst layer needs to be positioned in a manner that the catalyst layer is in contact with the polymer electrolyte membrane in each electrode. A pressure and temperature in hot pressing may be in accordance with a conventional method.

The resultant membrane electrode assembly can be formed into a polymer electrolyte fuel cell together with a separator and the like in accordance with a conventional method. The polymer electrolyte fuel cell of the present invention thus obtained is highly excellent in power generation performance since the fuel cell has a high performance electrode catalyst. Therefore, the polymer electrolyte fuel cell of the present invention is suitable for a power source for mobile devices and automobile, for household power generation system, or the like.

### EXAMPLES

Hereinafter, the present invention will be described in more detail with reference to Examples, but the present invention is not restricted by the following Examples and can be suitably modified within the scope described above or below to work out, and such modifications are also included in the technical scope of the present invention.

### Example of Preparing Catalyst 1

### Electrode Catalyst Using the Carrier (1)

### Pt.Ru/MgTiO₃

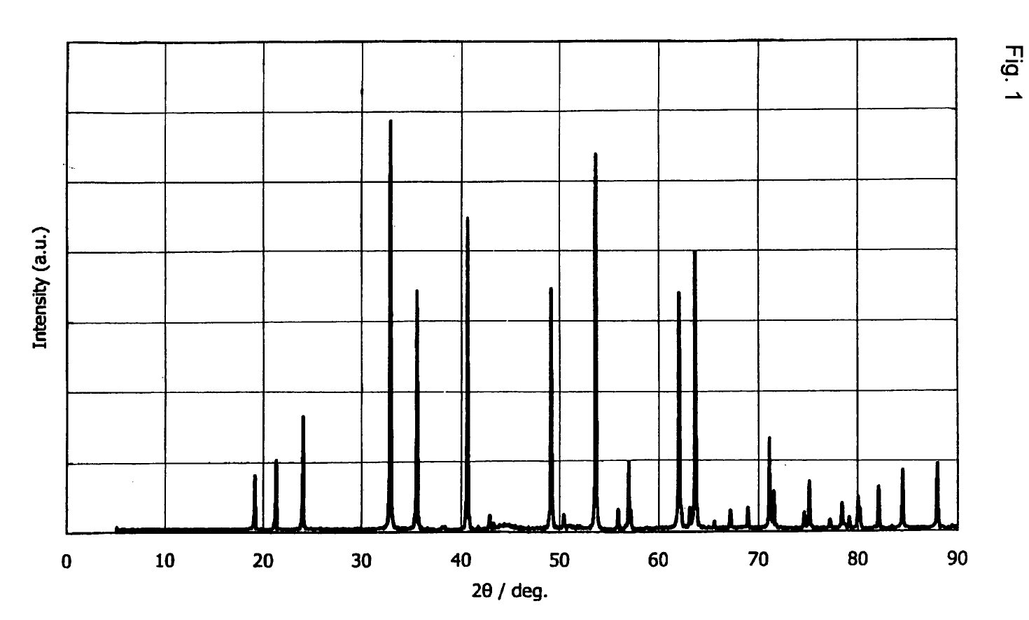

A powder was obtained by homogenously mixing 8.4 g of magnesium carbonate and 8 g of titanium oxide and calcining the mixture at 1300° C. for 20 hours. A powder X-ray diffraction chart of the powder is shown in FIG. 1. In the chart, a diffraction peak attributed to MgTiO₃ was detected, and the powder was ascertained to be crystalline magnesium titanate. A specific surface area of the powder was 3 m²/g.

Next, after a mixture solution of diamine dinitro platinum and ruthenium nitrate was impregnated with the powder, the powder was dried in nitrogen atmosphere at 90° C. The dried powder was subjected to reduction treatment at 300° C. for 2 hours using a hydrogen-containing gas to obtain an electrode catalyst. The catalyst had a composition of platinum:ruthenium:magnesium titanate (Pt:Ru:MgTiO₃)=40:20:40 (% by mass). The electrode catalyst is herein referred to as Example 1.

### Example of Preparing Catalyst 2

### Electrode Catalyst Using the Carrier (1)

### Pt.Ru/BaTiO₃

A powder was obtained by homogenously mixing 19.7 g of barium carbonate and 8 g of titanium oxide and calcining the mixture at 1300° C. for 20 hours. In the powder X-ray diffraction chart of the powder, a diffraction peak attributed to BaTiO₃ was detected, and the powder was ascertained to be crystalline barium titanate. A specific surface area of the powder was 4 m²/g.

Next, after a mixture solution of diamine dinitro platinum and ruthenium nitrate was impregnated with the powder, the powder was dried in nitrogen atmosphere at 90° C. The dried powder was subjected to reduction treatment at 300° C. for 2 hours using a hydrogen-containing gas to obtain an electrode catalyst. The electrode catalyst had a composition of platinum:ruthenium:barium titanate (Pt:Ru:BaTiO₃)=40:20:40 (% by mass). The electrode catalyst is herein referred to as Example 2.

### Example of Preparing Catalyst 3

### Electrode Catalyst Using the Carrier (1)

### Pt.Ru/ZrTiO₄

Into 1 liter of water, 19.9 g of zirconium oxychloride (ZrOCl₂.8H₂O) was dissolved, and 29.6 mL of a sulfuric solution of titanyl sulfate (250 g/L as TiO₂, sulfuric concentration of 100 g/L) was dropped into the stirred mixture little by little. The mixture was maintained at a temperature of about 30° C., and aqueous ammonia solution was dropped into the well stirred mixture until pH thereof became 7, and the mixture was kept still further for 15 hours. A gel thus obtained was filtrated and rinsed with water followed by drying at 200° C. for 10 hours, and thereafter was calcined in air atmosphere at 1400° C. for 20 hours to obtain a powder. In the powder X-ray diffraction chart of the powder, a diffraction peak attributed to ZrTiO₄ was detected, and the powder was ascertained to be crystalline titanate zirconium. A specific surface area of the powder was 6 m²/g.

Next, after a mixture solution of diamine dinitro platinum and ruthenium nitrate was impregnated with the powder, the powder was dried in nitrogen atmosphere at 90° C. and was subjected to reduction treatment at 300° C. for 2 hours using a hydrogen-containing gas to obtain an electrode catalyst. The electrode catalyst had a composition of platinum:ruthenium:zirconium titanate (Pt:Ru:ZrTiO₃)=40:20:40 (% by mass). The electrode catalyst is herein referred to as Example 3.

### Example of Preparing Catalyst 4

### Electrode Catalyst Using the Carrier (1)

### Pt.Ru/ZrTiO₄

Into 1 liter of water, 19.9 g of zirconium oxychloride (ZrOCl₂.8H₂O) was dissolved, and 29.6 mL of sulfuric solution of titanyl sulfate (250 g/L as TiO₂, sulfuric concentration of 100 g/L) was dropped into the well stirred mixture little by little. The mixture was maintained at a temperature of about 30° C., and aqueous ammonia solution was dropped into the well stirred mixture until pH thereof became 7, and the mixture was kept still further for 15 hours. A gel thus obtained was filtrated and rinsed with water followed by drying at 200° C. for 10 hours, and thereafter was calcined in air atmosphere at 1200° C. for 20 hours to obtain a powder. In the powder X-ray diffraction chart of the powder, a diffraction peak attributed to ZrTiO₄ was detected, and the powder was ascertained to be crystalline titanate zirconium. A specific surface area of the powder was 16 m²/g.

Next, after a mixture solution of diamine dinitro platinum and ruthenium nitrate was impregnated with the powder, the powder was dried in nitrogen atmosphere at 90° C. and was subjected to reduction treatment at 300° C. for 2 hours using a hydrogen-containing gas to obtain an electrode catalyst. The electrode catalyst had a composition of platinum:ruthenium:zirconium titanate (Pt:Ru:ZrTiO₃)=40:20:40 (% by mass). The electrode catalyst is herein referred to as Example 4.

### Example of Preparing Catalyst 5

### Electrode Catalyst Using the Carrier (1)

### Pt.Ru/ZrTiO₄

Into 1 liter of water, 19.9 g of zirconium oxychloride (ZrOCl₂.8H₂O) was dissolved, and 29.6 mL of sulfuric solution of titanyl sulfate (250 g/L as TiO₂, sulfuric concentration of 1100 g/L) was dropped into the stirred mixture little by little. The mixture was maintained at a temperature of about 30° C., and aqueous ammonia solution was dropped into the well stirred mixture until pH thereof became 7, and the mixture was kept still further for 15 hours. A gel thus obtained was filtrated and rinsed with water followed by drying at 200° C. for 10 hours, and thereafter was calcined in air atmosphere at 950° C. for 20 hours to obtain a powder. In the powder X-ray diffraction chart of the powder, a diffraction peak attributed to ZrTiO₄ was detected, and the powder was ascertained to be crystalline zirconium titanate. A specific surface area of the powder was 40 m²/g.

Next, after a mixture solution of diamine dinitro platinum and ruthenium nitrate was impregnated with the powder, the powder was dried in nitrogen atmosphere at 90° C. and was subjected to reduction treatment at 300° C. for 2 hours using a hydrogen-containing gas to obtain an electrode catalyst. The electrode catalyst had a composition of platinum:ruthenium:zirconium titanate (Pt:Ru:ZrTiO₃)=40:20:40 (% by mass). The electrode catalyst is herein referred to as Example 5.

### Example of Preparing Catalyst 6

### Electrode Catalyst Using the Carrier (1)

### Pt.Ru.NiO/ZrTiO₄

After an aqueous solution of nickel nitrate was impregnated with the zirconium titanate powder obtained in Example of preparing catalyst 3, the powder was dried in nitrogen atmosphere at 90° C. and then was calcined in air at 450° C. for 2 hours, so that nickel oxide was supported on zirconium titanate. A mixture solution of diamine dinitro platinum and ruthenium nitrate was impregnated with the nickel oxide-containing zirconium titanate thus obtained. The zirconium titanate was dried in nitrogen atmosphere at 90° C., and thereafter reduction treatment was carried out at 300° C. for 2 hours using a hydrogen-containing gas to obtain an electrode catalyst. The electrode catalyst had a composition of platinum:ruthenium:nickel oxide:zirconium titanate (Pt:Ru:NiO:ZrTiO₄)=40:20:5:35 (% by mass). The electrode catalyst is herein referred to as Example 6.

### Example of Preparing Catalyst 7

### Electrode Catalyst Using the Carrier (1)

### Pt.Ru.CeO₂/ZrTiO₄

An electrode catalyst was prepared in a same manner as Example of preparing catalyst 6 except that an aqueous solution of cerium nitrate was used instead of the aqueous solution of nickel nitrate. The electrode catalyst had a composition of platinum:ruthenium:cerium oxide:zirconium titanate (Pt:Ru:CeO₂:ZrTiO₂=40:20:5:35 (% by mass). The electrode catalyst is herein referred to as Example 7.

### Example of Preparing Catalyst 8

### Electrode Catalyst Using the Carrier (1)

### Pt.Ru.WO₃/MgTiO₄

After an aqueous solution of ammonium metatungstate was impregnated with the magnesium titanate powder obtained in Example of preparing catalyst 1, the powder was dried in nitrogen atmosphere at 90° C. and then was calcined in air at 450° C. for 2 hours, so that tungsten oxide was supported on magnesium titanate. After a mixture solution of diamine dinitro platinum and ruthenium nitrate was impregnated with tungsten oxide-containing magnesium titanate thus obtained, the magnesium titanate was dried in nitrogen atmosphere at 90° C., and thereafter reduction treatment was carried out at 300° C. for 2 hours using a hydrogen-containing gas to prepare an electrode catalyst. The electrode catalyst had a composition of platinum:ruthenium:tungsten oxide:magnesium titanate (Pt:Ru:WO₃:MgTiO₃)=40:20:5:35 (% by mass). The electrode catalyst is herein referred to as Example 8.

### Example of Preparing Catalyst 9

### Conventional Electrode Catalyst

### Pt.Ru/Carbon Black

An electrode catalyst was prepared in a same manner as Example of preparing catalyst 1 except that a carbon black (Vulcan XC72: specific surface area 250 m²/g, manufactured by Cabot Corporation) was used instead of the magnesium titanate. The electrode catalyst had a composition of platinum:ruthenium:carbon black (Pt:Ru:C)=40:20:40 (% by mass). The electrode catalyst is herein referred to as Comparative Example 1.

### Example of Preparing Catalyst 10

### Conventional Electrode Catalyst

### Pt.Ru/TiO₂

An electrode catalyst was prepared in a same manner as Example of preparing catalyst 1 except that titanium oxide (DT51: specific surface area of 93 m²/g manufactured by Rohne Poulenc) was used instead of the magnesium titanate. The electrode catalyst had a composition of platinum:ruthenium:titanium oxide (Pt:Ru:TiO₂)=40:20:40 (% by mass). The electrode catalyst is herein referred to as Comparative Example 2.

### Example of Preparing Catalyst 11

### Conventional Electrode Catalyst

### Pt.Ru/ZrO₂

An electrode catalyst was prepared in a same manner as Example of preparing catalyst 1 except that zirconium oxide (EPL, specific surface area of 101 m²/g manufactured by Daiichi Kigenso Kagaku Kogyo Co., Ltd.) was used instead of the magnesium titanate. The electrode catalyst had a composition of platinum:ruthenium:zirconium oxide (Pt:Ru:ZrO₂)=40:20:40 (% by mass). The electrode catalyst is herein referred to as Comparative Example 3.

### Test Example 1

### Performance Evaluation

Performance of the electrode catalysts of Examples 1 to 8 and Comparative Examples 1 to 3 obtained in Examples of preparing catalyst 1 to 11 was evaluated. Evaluation of catalyst performance was conducted by rotating disk electrode method. The method is effective for evaluating an electrode catalyst for solid polymer fuel cell, and a good correlation with fuel cell performance can be obtained by the method.

To 1 mL of 5% Nafion solution (manufactured by Aldrich), 10 mg of each of the catalyst and 10 mg of carbon black (Vulcan XC72 manufactured by Cabot Corporation) were added, and the catalyst and carbon black were ultrasonically dispersed to prepare a catalyst paste. Then, 5 μL of the catalyst paste was applied on a glassy carbon electrode and was sufficiently dried, and the catalyst layer was fixed on the glassy carbon electrode to form a test electrode. With respect to catalyst performance, methanol was added to 1 N aqueous solution of sulfuric acid so as to be 1 mol/L, and the test electrode was immersed in the solution to give a working electrode. A platinum wire is used for a counter electrode and reversible hydrogen electrode (RHE) is used for a reference electrode. A relation between methanol oxidation current and electrode potential was recorded by potential control method, thereby obtaining an oxidation current value in 0.7 V vs. RHE. It shows that the higher the oxidation current value is, the superior the catalyst performance is. Results are shown in Table 1.

TABLE 1

| | | Specific | Oxidation |
|---|---|---|---|
| | Catalyst | surface area | current |
| | composition | (m²/g) | value (A) |
| Example 1 | Pt•Ru/MgTiO₃ | 3 | 2.9 |
| Example 2 | Pt•Ru/BaTiO₃ | 4 | 2.8 |
| Example 3 | Pt•Ru/ZrTiO₄ | 6 | 3.3 |
| Example 4 | Pt•Ru/ZrTiO₄ | 16 | 2.5 |
| Example 5 | Pt•Ru/ZrTiO₄ | 40 | 2.3 |
| Example 6 | Pt•Ru•NiO/ZrTiO₄ | 6 | 3.8 |
| Example 7 | Pt•Ru•CeO₂/ZrTiO₄ | 6 | 4.2 |
| Example 8 | Pt•Ru•WO₃/MgTiO₃ | 3 | 4.1 |
| Comparative | Pt•Ru/Carbon black | 250 | 1.8 |
| Example 1 | | | |
| Comparative | Pt•Ru/TiO₂ | 93 | 1.9 |
| Example 2 | | | |
| Comparative | Pt•Ru/ZrO₂ | 101 | 1.8 |
| Example 3 | | | |

As the results in Table 1, it was demonstrated that the electrode catalyst of the present invention in which a catalyst component is supported on a titanate has a superior catalyst performance, compared with a conventional electrode catalyst in which a catalyst component is supported on carbon black, titanium oxide or zirconium oxide. In addition, it was found that a more excellent catalyst performance can be obtained in case that a crystalline titanate having a specific surface area of 20 m²/g or less, particularly 10 m²/g or less among titanates is used. Further, it was found that superior catalyst performance can be obtained when a specific oxide is supported, compared with the case where the catalyst component alone is supported.

### Example of Preparing Catalyst 12

### Electrode Catalyst Using the Carrier (2)

### Pt.Ru/SiO₂

Tokusil GU which is amorphous silicon dioxide manufactured by Tokuyama Corporation having a specific surface area of 119 m²/g and an oil absorption value of 1.6 mL/g was dried at 110° C. The dried amorphous silicon dioxide was pulverized using an agate mortar. The size thereof was equalized with a mesh of 45 μm or less, and 0.7 g of the amorphous silicon dioxide was fed to 100 mL of anhydrous ethanol. The mixture was stirred and the amorphous silicon dioxide was suspended. Then, diamine dinitro platinum containing 0.692 g of platinum as a metal and ruthenium nitrate containing 0.358 g of ruthenium as a metal were dissolved in 100 mL of anhydrous ethanol. After the mixture was added to the anhydrous ethanol solution in which 0.7 g of the silicon dioxide was suspended and the mixture was stirred well, anhydrous ethanol was distilled away using a rotary evaporator under nitrogen stream while the temperature was maintained at 60 to 70° C. Then, reduction treatment was carried out using 5% hydrogen-containing nitrogen at 300° C. for 2 hours to prepare an electrode catalyst. The electrode catalyst had a composition of platinum:ruthenium:silicon dioxide (Pt:Ru:SiO₂)=40:20:40 by mass ratio, and an amount of catalyst metal supported was 60% by mass. The electrode catalyst is herein referred to as Example 9.

### Example of Preparing Catalyst 13

### Electrode Catalyst Using the Carrier (2)

### Pt.Ru/SiO₂

An electrode catalyst was prepared in a same manner as Example of preparing catalyst 12 except that Tokusil U which is amorphous silicon dioxide having a specific surface area of 183 m²/g and an oil absorption value of 1.8 mL/g manufactured by Tokuyama Corporation was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to electrode catalyst was 60% by mass. The electrode catalyst is herein referred to as Example 10.

### Example of Preparing Catalyst 14

### Electrode Catalyst Using the Carrier (2)

### Pt.Ru/SiO₂

An electrode catalyst was prepared in a same manner as Example of preparing catalyst 12 except that Tokusil NR which is amorphous silicon dioxide having a specific surface area of 195 m²/g and an oil absorption value of 2.5 mL/g manufactured by Tokuyama Corporation was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to electrode catalyst was 60% by mass. The electrode catalyst is herein referred to as Example 11.

### Example of Preparing Catalyst 15

### Electrode Catalyst Using the carrier (2)

### Pt.Ru/SiO₂

An electrode catalyst was prepared in a same manner as Example of preparing catalyst 12 except that Nipgel AZ200 which is amorphous silicon dioxide having a specific surface area of 290 m²/g and an oil absorption value of 3.6 mL/g manufactured by Tosoh Silica Corporation was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to electrode catalyst was 60% by mass. The electrode catalyst is herein referred to as Example 12.

### Example of Preparing Catalyst 16

### Electrode Catalyst Using the Carrier (2)

### Pt.Ru/SiO₂

An electrode catalyst was prepared in a same manner as Example of preparing catalyst 12 except that Nipgel BY400 which is amorphous silicon dioxide having a specific surface area of 450 m²/g and an oil absorption value of 2.1 mL/g manufactured by Tosoh Silica Corporation was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to the electrode catalyst was 60% by mass. The electrode catalyst is herein referred to as Example 13.

### Example of Preparing Catalyst 17

### Conventional Electrode Catalyst

### Pt.Ru/SiO₂

An electrode catalyst was prepared in a same manner as Example of preparing catalyst 13 except that an ethanol solution of diamine dinitro platinum-ruthenium nitrate was changed to a solution in which diamine dinitro platinum containing 0.081 g of platinum as metal and ruthenium nitrate containing 0.042 g of ruthenium as metal were dissolved in 100 mL of anhydrous ethanol. The electrode catalyst had a composition of platinum:ruthenium:silicon dioxide (Pt:Ru:SiO₂)=10:5:85 by mass ratio, and an amount of catalyst component supported with respect to the electrode catalyst was 15% by mass. The electrode catalyst is herein referred to as Comparative Example 4.

### Example of Preparing Catalyst 18

### Conventional Electrode Catalyst

### Pt.Ru/SiO₂

An electrode catalyst was prepared in a same manner as Example of preparing catalyst 13 except that the ethanol solution of diamine dinitro platinum-ruthenium nitrate was changed to a solution in which diamine dinitro platinum containing 0.198 g of platinum as metal and ruthenium nitrate containing 0.102 g of ruthenium as metal were dissolved in 100 mL of anhydrous ethanol. The electrode catalyst had a composition of platinum:ruthenium:silicon dioxide (Pt:Ru:SiO₂)=20:10:70 by mass ratio, and an amount of catalyst component supported with respect to the electrode catalyst was 30% by mass. The electrode catalyst is herein referred to as Comparative Example 5.

### Example of Preparing Catalyst 19

### Electrode Catalyst Using the Carrier (2)

### Pt.Ru/SiO₂

An electrode catalyst was prepared in a same manner as Example of preparing catalyst 13 except that the ethanol solution of diamine dinitro platinum-ruthenium nitrate was changed to a solution in which diamine dinitro platinum containing 0.461 g of platinum as metal and ruthenium nitrate containing 0.239 g of ruthenium as metal were dissolved in 100 mL of anhydrous ethanol. The electrode catalyst had a composition of platinum:ruthenium:silicon dioxide (Pt:Ru:SiO₂)=33:17:50 by mass ratio, and an amount of catalyst component supported with respect to the electrode catalyst was 50% by mass. The electrode catalyst is herein referred to as Example 14.

### Example of Preparing Catalyst 20

### Electrode Catalyst Using the Carrier (2)

### Pt.Ru/SiO₂

An electrode catalyst was prepared in a same manner as Example of preparing catalyst 13 except that the ethanol solution of diamine dinitro platinum-ruthenium nitrate was changed to a solution in which diamine dinitro platinum containing 1.84 g of platinum as metal and ruthenium nitrate containing 0.956 g of ruthenium as metal were dissolved in 100 mL of anhydrous ethanol. The electrode catalyst had a composition of platinum:ruthenium:silicon dioxide (Pt:Ru:SiO₂)=53:27:20 by mass ratio, and an amount of catalyst component supported with respect to the electrode catalyst was 80% by mass. The electrode catalyst is herein referred to as Example 15.

### Example of Preparing Catalyst 21

### Conventional Electrode Catalyst

### Pt.Ru/SiO₂

An electrode catalyst was prepared in a same manner as Example of preparing catalyst 13 except that the ethanol solution of diamine dinitro platinum-ruthenium nitrate was changed to a solution in which diamine dinitro platinum containing 4.15 g of platinum as metal and ruthenium nitrate containing 2.15 g of ruthenium as metal were dissolved in 100 mL of anhydrous ethanol. The electrode catalyst had a composition of platinum:ruthenium:silicon dioxide (Pt:Ru:SiO₂)=60:30:10 by mass ratio, and an amount of catalyst component supported with respect to the electrode catalyst was 90% by mass. The electrode catalyst is herein referred to as Comparative Example 6.

### Example of Preparing Catalyst 22

### Electrode Catalyst Using the Carrier (2)

### Pt.Ru.CeO₂/SiO₂

After Tokusil U which is amorphous silicon dioxide having a specific surface area of 183 m²/g and an oil absorption value of 1.8 mL/g manufactured by Tokuyama Corporation was dried at 110° C., the amorphous silicon dioxide was pulverized with an agate mortar, and the size thereof was equalized with a mesh of 45 μm or less. Then, 1.0 g of the amorphous silicon dioxide was added in an aqueous solution in which 0.105 g of cerium nitrate.hexahydrate was dissolved and the mixture was stirred well, and thereafter water therein was evaporated using a rotary evaporator under nitrogen stream at 100° C. The resultant powder was calcined in air at 450° C. for 2 hours so that cerium oxide was supported on silicon dioxide.

Then, the cerium oxide-supporting silicon dioxide was pulverized by an agate mortar and the size thereof was equalized with a mesh of 45 μm or less, and 0.7 g of the silicon dioxide was fed into 100 mL anhydrous ethanol. The mixture was stirred, and the silicon dioxide was suspended. Next, diamine dinitro platinum containing 0.692 g of platinum as a metal and ruthenium nitrate containing 0.358 g of ruthenium as a metal were dissolved in 100 mL of anhydrous ethanol. After the mixture was added to the anhydrous ethanol solution in which 0.7 g of cerium oxide-supporting silicon dioxide was suspended and stirred well, anhydrous ethanol was evaporated using a rotary evaporator under nitrogen stream at 60 to 70° C. Thereafter, reduction treatment was carried out using 5% hydrogen-containing nitrogen at 300° C. for 2 hours to prepare an electrode catalyst. The electrode catalyst had a composition of platinum:ruthenium:cerium oxide:silicon dioxide (Pt:Ru:CeO₂:SiO₂)=40:20:2:38 by mass ratio, and an amount of catalyst component supported with respect to the electrode catalyst was 60% by mass. The electrode catalyst is herein referred to as Example 16.

### Example of Preparing Catalyst 23

### Electrode Catalyst Using the Carrier (2)

### Pt.Ru.La₂O₃/SiO₂

An electrode catalyst was prepared in a same manner as Example of preparing catalyst 22 except that 0.105 g of cerium nitrate.hexahydrate was changed to 0.14 g of lanthanum nitrate.hexahydrate. The electrode catalyst had a composition of platinum:ruthenium:lanthanum oxide:silicon dioxide (Pt:Ru:La₂O₃:SiO₂)=40:20:2:38 by mass ratio, and an amount of catalyst component supported with respect to the electrode catalyst was 60% by mass. The electrode catalyst is herein referred to as Example 17.

### Example of Preparing Catalyst 24

### Electrode Catalyst Using the carrier (2)

### Pt.Ru.Ta₂O₅/SiO₂

An electrode catalyst was prepared in a same manner as Example of preparing catalyst 22 except that a solution in which 0.085 g of tantalum chloride was dissolved in anhydrous ethanol was used instead of the aqueous solution in which 0.105 g of cerium nitrate.hexahydrate was dissolved. The electrode catalyst had a composition of platinum:ruthenium:tantalum oxide:silicon dioxide (Pt:Ru:Ta₂O₅:SiO₂)=40:20:2:38, and an amount of catalyst component supported with respect to the electrode catalyst was 60% by mass. The electrode catalyst is herein referred to as Example 18.

### Example of Preparing Catalyst 25

### Conventional Electrode Catalyst

### Pt.Ru/SiO₂

An electrode catalyst was prepared in a same manner as Example of preparing catalyst 12 except that Nipgel CX200 which is amorphous silicon dioxide having a specific surface area of 689 m²/g and an oil absorption value of 1.2 mL/g manufactured by Tosoh Silica Corporation was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to the electrode catalyst was 60% by mass. The electrode catalyst is herein referred to as Comparative Example 7.

### Example of Preparing Catalyst 26

### Conventional Electrode Catalyst

### Pt.Ru/SiO₂

An electrode catalyst was prepared in a same manner as Example of preparing catalyst 12 except that Nipsil E-74P which is amorphous silicon dioxide having a specific surface area of 45 m²/g and an oil absorption value of 1.8 mL/g manufactured by Tosoh Silica Corporation was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to the electrode catalyst was 60% by mass. The electrode catalyst is herein referred to as Comparative Example 8.

### Example of Preparing Catalyst 27

### Conventional Electrode Catalyst

### Pt.Ru/SiO₂

An electrode catalyst was prepared in a same manner as Example of preparing catalyst 12 except that Sunsphere H-33 which is amorphous silicon dioxide having a specific surface area of 690 m²/g and an oil absorption value of 3.8 mL/g manufactured by Asahi Glass Co., Ltd. was used instead of Tokusil GU which is amorphous silicon dioxide manufactured by Tokuyama Corporation. The electrode catalyst had a composition of platinum:ruthenium:silicon dioxide (Pt:Ru:SiO₂)=40:20:40 by mass ratio, and an amount of catalyst component supported with respect to the electrode catalyst was 60% by mass. The electrode catalyst is herein referred to as Comparative Example 9.

### Example of Preparing Catalyst 28

### Conventional Electrode Catalyst

### Pt.Ru/SiO₂

An electrode catalyst was prepared in a same manner as Example of preparing catalyst 12 except that Ketjen Black EC which is carbon black having a specific surface area of 793 m²/g and an oil absorption value of 3.6 mL/g manufactured by Mitsubishi Chemical Corporation was used instead of Tokusil GU which is amorphous silicon dioxide manufactured by Tokuyama Corporation. The electrode catalyst had a composition of platinum:ruthenium:carbon black (Pt:Ru:C)=40:20:40 by mass ratio, and an amount of catalyst component supported with respect to the electrode catalyst was 60% by mass. The electrode catalyst is herein referred to as Comparative Example 10.

### Test Example 2

Performance of the electrode catalysts of Examples 9 to 18 and Comparative Examples 4 to 10 obtained in Examples of preparing catalyst 12 to 28 was evaluated. Evaluation of catalyst performance was conducted by rotating disk electrode method. The method is effective for evaluating an electrode catalyst for solid polymer fuel cell, and a good correlation with fuel cell performance can be obtained by the method.

To 1 mL of 5% Nafion solution (manufactured by Aldrich), 10 mg of each of the catalyst and 10 mg of carbon black (Vulcan XC72 manufactured by Cabot) were added, and the catalyst and carbon black were ultrasonically dispersed to prepare a catalyst paste. Then, the catalyst paste was applied on a glassy carbon electrode and was sufficiently dried, and the catalyst layer was fixed on the glassy carbon electrode to form a test electrode. For catalyst performance evaluation, methanol was added to 1 N aqueous solution of perchloric acid maintained at 25° C. so as to be 1 mol/L, and the test electrode was immersed in the solution to give a working electrode. A platinum wire was used for a counter electrode and reversible hydrogen electrode (RHE) was used for a reference electrode. A relation between methanol oxidation current and electrode potential was recorded by potential control method and comparing an oxidation current values in 0.7 V vs. RHE. It shows that the higher the oxidation current value is, the superior the catalyst performance is. Results are shown in Table 2. The value of the methanol oxidation current could be calculated by dividing the measured value of oxidation current by the weight of the catalyst component included in the catalyst applied on the glassy carbon electrode, that is, the value of the methanol oxidation current was the value of oxidation current per the weight of noble metal catalyst component.

TABLE 2

| | Silicon dioxide | | Supported component | | | Methanol |
|---|---|---|---|---|---|---|
| | | Oil | | | Amount of | oxidation |
| | BET specific | absorption | | | catalyst | current |
| | surface area | value | | Pt:Ru:oxide | suppored | value |
| | (m²/g) | (mL/g) | Oxide | (mass ratio) | (mass %) | (A/g) |
| Example 9 | 119 | 1.6 | — | 40:20:0 | 60% | 85 |
| Example 10 | 183 | 1.8 | — | 40:20:0 | 60% | 96 |
| Example 11 | 195 | 2.5 | — | 40:20:0 | 60% | 94 |
| Example 12 | 290 | 3.6 | — | 40:20:0 | 60% | 107 |
| Example 13 | 450 | 2.1 | — | 40:20:0 | 60% | 99 |
| Example 14 | 183 | 1.8 | — | 33:17:0 | 50% | 95 |
| Example 15 | 183 | 1.8 | — | 53:27:0 | 80% | 97 |
| Example 16 | 183 | 1.8 | CeO₂ | 40:20:2 | 60% | 115 |
| Example 17 | 183 | 1.8 | La₂O₃ | 40:20:2 | 60% | 109 |
| Example 18 | 183 | 1.8 | Ta₂O₅ | 40:20:2 | 60% | 106 |
| Comparative Example 7 | 689 | 1.2 | — | 40:20:0 | 60% | 62 |
| Comparative Example 8 | 45 | 1.8 | — | 40:20:0 | 60% | 59 |
| Comparative Example 9 | 690 | 3.8 | — | 40:20:0 | 60% | 67 |
| Comparative Example 10 | 793 | 3.8 | — | 40:20:0 | 60% | 67 |
| Comparative Example 4 | 183 | 1.8 | — | 10:5:0 | 15% | 32 |
| Comparative Example 5 | 183 | 1.8 | — | 20:10:0 | 30% | 68 |
| Comparative Example 6 | 183 | 1.8 | — | 60:30:0 | 90% | 72 |

The results in Table 2 indicate the following.

A good catalyst performance can be obtained by meeting all the conditions that SiO₂ as a carrier has a BET specific surface area of 100 to 500 m²/g, an oil absorption value of 1.6 to 3.7 mL/g, and an amount of catalytic active substance supported of 50 to 80% by mass.

A better catalyst performance can be obtained by supporting at least one kind of specific metal oxide in addition to catalyst components.

Further, the electrode catalysts of Example 9 to 13 and Comparative Examples 7 and 9 are picked up among the above catalysts, and a relation between the oil absorption value of SiO₂ and methanol oxidation current value is shown by a graph of FIG. 2. From the result, it is found that a good catalyst performance can be obtained in case that SiO₂ having an oil absorption value within a range from 1.6 to 3.7 mL/g is used as a carrier, while methanol oxidation current value is markedly lowered when the oil absorption value is 1.6 mL/g or less and 3.7 mL/g or more.

1. An electrode catalyst for fuel cell, wherein
a catalyst component is supported on a belowmentioned carrier (1) or (2), and
a percentage of the catalyst component in the electrode catalyst when the carrier (2) is selected is 50 to 80% by mass,
Carrier (1): Titanate
Carrier (2): SiO₂ having a BET specific surface area of 100 to 500 m²/g and an oil absorption value of 1.6 to 3.7 mL/g.

2. The electrode catalyst for fuel cell according to claim 1, wherein one, two or more oxides of metal selected from a group consisting of Ce, La, Ta, Ni, W, Re, In, Co, Mn, Nb, Ga, V, Zn and Y are further supported.

3. The electrode catalyst for fuel cell according to claim 1, having the carrier (1) with a specific surface area of 20 m²/g or less as the carrier.

4. The electrode catalyst for fuel cell according to claim 1, wherein the catalyst component is one, two or more selected from a group consisting of Pt, Pd, Ru, Rh, Ir, Au and Ag.

5. A electrode catalyst composition for fuel cell containing the fuel cell electrode catalyst according to claim 1, a conductive carbon material and a polymer electrolyte.

6. A fuel cell having an electrode formed of the electrode catalyst composition for fuel cell according to claim 5.

7. The electrode catalyst for fuel cell according to claim 2, having the carrier (1) with a specific surface area of 20 m²/g or less as the carrier.

8. The electrode catalyst for fuel cell according to claim 2, wherein the catalyst component is one, two or more selected from a group consisting of Pt, Pd, Ru, Rh, Ir, Au and Ag.

9. The electrode catalyst for fuel cell according to claim 3, wherein the catalyst component is one, two or more selected from a group consisting of Pt, Pd, Ru, Rh, Ir, Au and Ag.

10. A electrode catalyst composition for fuel cell containing the fuel cell electrode catalyst according to claim 2, a conductive carbon material and a polymer electrolyte.

11. A electrode catalyst composition for fuel cell containing the fuel cell electrode catalyst according to claim 3, a conductive carbon material and a polymer electrolyte.

12. A electrode catalyst composition for fuel cell containing the fuel cell electrode catalyst according to claim 4, a conductive carbon material and a polymer electrolyte.
